(19) United States
(12) Patent Application Publication
(10) Pub. No.: US 2015/0295242 A1
(43) Pub. Date: Oct. 15, 2015

(54) METHOD FOR PREPARING PARTIALLY SURFACE-PROTECTED ACTIVE MATERIALS FOR LITHIUM BATTERIES

(71) Applicant: RENAULT s.a.s., Boulogne-Billancourt (FR)

(72) Inventors: Jean-Baptiste Ducros, Sassenage (FR); Jean Frederic Martin, Grenoble (FR); Gregory Douglade, Grenoble (FR)

(73) Assignee: RENAULT s.a.s., Boulogne-Billancourt (FR)

(21) Appl. No.: 14/420,459

(22) PCT Filed: Jul. 31, 2013
(86) PCT No.: PCT/FR2013/051857

§ 371 Date: Jun. 24, 2015

(30) Foreign Application Priority Data
Aug. 9, 2012 (FR) 1257730

(51) Int. Cl. H01M 4/58; H01M 4/485

(52) U.S. Cl. CPC H01M 4/5825; H01M 4/485

(57) ABSTRACT

The present invention relates to a method for preparing particles intended to be used, as active materials, within a composite electrode for lithium batteries, which are coated with at least one layer of oxide, preferably a layer of metal oxide covering only the areas which are capable of being more reactive with an electrolyte based on lithium hexafluorophosphate LiPF6.

The present invention relates to a process for the preparation of particles, intended to be used as active materials within a composite electrode for lithium batteries, which are coated with at least one layer of oxide, preferably a layer of metal oxide, covering solely the regions which are allowed to be more reactive with an electrolyte based on lithium hexafluorophosphate LiPF₆.

Lithium batteries occupy an increasingly important place in the electrical energy storage market. This is because their current performance, in particular with regard to the storage of electrical energy, exceeds by far the former technologies based on nickel batteries, such as nickel-metal hydride NiMH batteries or nickel-cadmium NiCd batteries.

Among lithium batteries, lithium-ion batteries are rechargeable batteries which are particularly advantageous as they can advantageously be used as energy source in portable electronic devices, such as mobile phones and laptops, in particular by virtue of their low cost price, which could be reduced by two thirds in ten years, or in the motor vehicle field, in particular electric cars, which requires an increased lifetime, an enhanced electrochemical performance and an increased safety level.

Like any energy storage system, lithium-ion batteries comprise a positive electrode, originally formed with an oxide of lamellar type, such as lithium cobalt oxide LiCoO₂, as active material, a negative electrode, initially composed of carbon-based materials, such as graphite, and an electrolyte impregnated in a porous separator and generally composed of a mixture of carbonates and of a lithium salt, in particular lithium hexafluorophosphate LiPF₆.

Research to enhance the electrochemical performance of lithium batteries has resulted in an improvement in the technical characteristics of electrochemical cells (for example, an improvement in the thickness of the electrodes, in the size of the electrochemical cell or in the formulation of the composite electrodes) and also the development of novel electrochemical systems, in particular by providing other materials for the manufacture of the electrodes. To this end, the use of mixed lamellar materials of Li(Ni, Mn, Co, Al)O₂ type, or phosphates of LiFePO₄ or LiMnPO₄ type or also of materials of spinel LiNiₓMn₂₋ₓO₄ type has been developed for the manufacture of the positive electrodes. As regards the negative electrode, carbon-based materials (coke, natural and artificial graphite, mesoporous carbon microbeads (MCMB), and the like), lithium titanates of Li₄Ti₅O₁₂ type or also materials capable of forming an alloy with lithium, such as silicon, tin or aluminum, are reencountered. Given that each type of material is limited by its intrinsic properties, lithium batteries having different specificities are obtained. For example, it is possible to obtain electrochemical systems having a high charging or discharging power for low storage energies, or vice versa. Likewise, some materials make it possible to achieve a saving with regard to the cost or the safety of the batteries, and also with regard to their longevity or their ability to be rapidly recharged.

In particular, the use of spinel materials of LiNiₓMn₂₋ₓO₄ type has proved to be advantageous for the manufacture of the positive electrodes as these materials have a low cost price, due to the abundance of manganese, and exhibit a high operating potential of the order of 4.7V vs. Li⁺/Li, which makes it possible to gain approximately 1 volt with respect to conventional electrochemical systems using materials such as lithium cobalt oxide LiCoO₂. Thus, the specific storage energy changes from 540 Wh·kg⁻¹ for a system comprising a positive electrode using lithium cobalt oxide LiCoO₂ to 700 Wh·kg⁻¹ for a system, the positive electrode of which is formed from spinel materials. The systems using spinel materials of LiNiₓMn₂₋ₓO₄ type thus exhibit a certain number of advantages and make it possible at the same time to achieve high charging and discharging powers.

However, it has been found that the electrodes manufactured from spinel materials of LiNiₓMn₂₋ₓO₄ type exhibit the disadvantage of having a reduced lifetime during galvanostatic cycling operation(s), that is to say during the cycles comprising the charging and discharging of the electrochemical cell, since the cycling temperature increases. Such a limitation on the lifetime of this type of electrode is due in particular to the deterioration in the electrolyte during the operation of the battery. This is because the lithium hexafluorophosphate LiPF₆ decomposes, giving rise to the appearance of lithium fluoride LiF and phosphorus pentafluoride PF₅, according to the following mechanism:

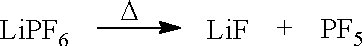

The presence of phosphorus pentafluoride within the electrolyte then contributes, in the presence of molecules of water, to the generation of hydrofluoric acid HF and phosphoryl fluoride OPF₃, according to the following reaction:

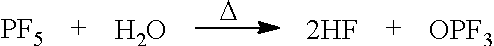

The presence of hydrofluoric acid within the electrolyte thus has a tendency to promote and increase the rate of dissolution of the manganese within the electrolyte, thus resulting in the decomposition of the electrode during galvanostatic cycling operations. Furthermore, the reaction between the electrolyte and the spinel materials of LiNiₓMn₂₋ₓO₄ type results in the formation of a passivation layer at the surface of the grains of the active materials, which brings about a deterioration in their electrochemical performance.

In order to overcome these disadvantages and improve the lifetime of the active materials of LiNiₓMn₂₋ₓO₄ type during high temperature galvanostatic cycling operations, the proposal has been made to coat the materials by grafting, to their surface, a layer of low thickness, generally ranging from 1 to 10 nanometers, composed of metal oxides or fluorides or also of phosphates. The coating thus obtained makes it possible to prevent direct contact between the electrolyte and the grain of the active material, which has the consequence of stabilizing the interface between the electrode and the electrolyte and also the rate of transfer of charge during the cycling. The coating thus makes it possible to protect the active materials from the deterioration in the electrolyte.

The metal oxides capable of being able to be used as coating are in particular alumina Al₂O₃, zirconium dioxide ZrO₂ or tin dioxide SnO₂. Coatings based on aluminum trifluoride AlF₃ or more generally based on metal halides can also be grafted to the surface of the active materials. Phosphates, such as aluminum orthophosphate AlPO₄ and boron phosphate BPO₄, can also be used as coating. Such coatings are described in particular in the patent applications WO 2011/031544, WO 2006/109930 and US 2011/0111298.

The coatings based on metal oxides or fluorides can be produced from a sol-gel process, from a process by coprecipitation and also via chemical vapor deposition (CVD) or physical vapor deposition (PVD).

The coating of the active materials produced via a coprecipitation is generally carried out in an aqueous solvent, in which a metal salt has been dissolved. The particles to be coated are subsequently dispersed in the medium and the pH of the solution is modified by addition of an acid or of a base in order for the salt to precipitate in the metal oxide form at the surface of the particles to be coated. The solvent is subsequently evaporated and the recovered coated particles are annealed at temperatures of several hundred degrees, ranging from 250 to 800° C., for several hours. The annealing can be carried out under air for particles coated with a metal oxide and under inert atmosphere for particles coated with a metal fluoride. Generally, coatings produced from metal halides can also be obtained via a coprecipitation method by dispersing an ammonium halide salt NH₄X, with X corresponding to a halogen atom, in an aqueous solvent.

The coating of the active materials by a sol-gel process is generally carried out by employing metal alkoxides as precursors. The metal alkoxides are thus dissolved in a nonaqueous solvent, preferably an alcohol, so as to obtain a solution, and then the particles to be coated are subsequently dispersed in said solution. The solution is mixed for several hours at a temperature of 80° C. while allowing the solvent to slowly evaporate. The particles are subsequently recovered and annealed for five hours under air at temperatures which can be of the order of 400° C.

In particular, provision has already been made to produce a coating by carrying out a sol-gel process using a chelating agent, such as acetylacetone (N. Machida et al., Solid State Ion., 2011). A solution of zirconium precursor is prepared from isopropanol, zirconium tetrapropoxide (Zr(OC₃H₇)₄), acetylacetone and water in 170/1/1.5/6 molar ratios. The particles to be coated (LiNi_{1/3}Mn_{1/3}CO_{1/3}O₂) are subsequently added and the solution obtained is stirred under ultrasound at 40° C. for 30 minutes. The solvent is subsequently evaporated under vacuum. The volume of the precursor solution, in which the LiNi_{0.4}Mn_{1.6}O₄ particles are dispersed is calculated so as to obtain a final amount of ZrO₂ of between 0.35 and 3.5 mol %. The powders obtained are subsequently heated at 750° C. for two hours under oxygen.

However, it is found that the particles (LiNi_{1/3}Mn_{1/3}CO_{1/3}O₂) obtained following this process comprise, at their surface, a deposit of zirconium dioxide (ZrO₂) particles and not a layer composed of zirconium dioxide. In other words, this process does not make it possible to result in the preparation of a layer of zirconium dioxide covering the particles and, consequently, does not effectively protect the active materials during the galvanostatic cycling operations.

In an alternative form, provision has also been made to produce a coating of ZrO₂ type by using a precursor of ZrCl₄ metal salt type (H. M. Wu et al., J. Power Sources, 195, 2010, 2909). This salt is dissolved in ether and then the particles to be coated are added. The ZrCl₄ particles gradually form ZrO₂ particles, insoluble in ether, which cover the surface of the particles to be coated. The remaining solvent is subsequently evaporated under vacuum and the powder is calcined at 400° C. for six hours. Following this process, particles are also obtained which comprise, at their surface, a deposit of particles of zirconium dioxide (ZrO₂) and not a layer composing zirconium dioxide (ZrO₂).

Thus, it results therefrom that the processes employed still do not make it possible to result in particles, intended to be used as active materials in a composite electrode of a lithium battery, which are suitably coated starting from metal oxides, generally from oxides, and the reactivity of which with regard to an electrolyte based on lithium hexafluorophosphate LiPF₆ is satisfactorily reduced in order to result in a stable electrochemical system.

In the light of the above, the aim of the invention is in particular to provide a process which makes it possible to result in particles coated with a layer composed of oxide, in particular of metal oxide, which are intended to be used as active materials in a composite electrode of a lithium battery in order to reduce their reactivity during the galvanostatic cycling operations, including at high temperature, and to obtain a better electrochemical stability.

To this end, it has been found that, by employing a process in which particles of spinel type as described hereinbelow, intended to be used as active materials in a composite electrode of a lithium battery, are prepared which are covered with a layer of oxide, in particular of metal oxide, at regions which are the most liable to react with an electrolyte based on lithium hexafluorophosphate LiPF₆, while keeping uncovered with a layer of oxide the regions least liable to react with said electrolyte, it is possible to reduce the reactivity of the active materials during galvanostatic cycling operations while retaining very good electrochemical properties.

In other words, the process according to the invention thus consists in particular in partially coating the particles as defined above in order to cover the regions which are the most reactive with regard to an electrolyte based on lithium hexafluorophosphate LiPF₆ while keeping clear the regions least reactive with regard to this electrolyte.

Thus, the particles are locally covered, on the regions most reactive with regard to the electrolyte, with layers of oxide, in particular of metal oxide, which are uniform and dense.

The particles obtained following this process are thus less subject to any chemical and/or electrochemical reaction.

The process thus results in the preparation of particles, only the most reactive portions of which are protected with regard to the electrolyte, which makes it possible to greatly reduce the reactivity of said particles at a high operating potential.

In particular, once the electrode is subjected to a high operating potential, the deterioration in the electrode, which is liable to take place following the change in the electrolyte, is limited.

Furthermore, the fact of having available particles having regions which are not covered with a layer of oxide, that is to say having clear portions, makes it possible to promote the installation and the circulation of the lithium ions more effectively than if the particles had been covered. In other words, the partial covering of the particles acting as active materials within a composite electrode in a lithium battery promotes circulation of the lithium ions during the charging or the discharging of the electrochemical cell.

Thus, unlike particles which would exhibit a uniform and dense coating over the whole of their surface, the particles obtained with the process in accordance with the invention do not result in a loss in discharge capacity, given that they result in an improvement in the kinetics of insertion of the lithium ions. This is because the uniform covering of the particles over the whole of their surface has a tendency to slow down the circulation of the lithium ions within the electrochemical cell.

The process in accordance with the present invention exhibits the advantage of being more economical than a chemical vapor deposition or physical vapor deposition process.

The process thus employed therefore makes it possible to prepare particles which are suitably coated with a layer of oxide, preferably of metal oxide, so as to effectively reduce their reactivity with regard to an electrolyte of a lithium battery.

A subject matter of the present invention is thus in particular a process, in particular an anhydrous process in which no addition of water is carried out, for the preparation of particles, which are intended to be used as active materials in a composite electrode of a lithium battery, comprising at least one region (a) and at least one region (b), said region (a) being more liable to react with an electrolyte based on lithium hexafluorophosphate LiPF₆ than said region (b), said process comprising:

(i) a stage which consists in dispersing, in an anhydrous composition (1), particles of lithium oxide of formulae:
LiM′PO₄, in which M′ is chosen from iron, cobalt, manganese and the mixtures of these,
LiM″O₂, in which M″ is chosen from nickel, cobalt, manganese, aluminum and the mixtures of these,
LiM′″₂O₄, in which M′″ is chosen from nickel and manganese and the mixtures of these,
Li₄Ti₅O₁₂,
   (ii) a stage which consists in preparing an anhydrous composition (2) comprising at least one alkoxide compound of formula R¹ₜ(R²X)ᵤA(OR³)_{z-(t+u)}, in which:
   t varies from 0 to 2,
   u varies from 0 to 2,
   the sum t+u varies from 0 to 2,
   z varies from 2 to 4,
   X corresponds to a halogen atom, such as fluorine or chlorine,
   A is chosen from the transition metals and the elements of Groups IIIA and IVA of the Periodic Table of the Elements,
   R¹ represents a linear or branched C₁-C₈ alkyl radical,
   R² represents a single bond or a linear or branched C₁-C₈ alkyl radical,
   R³ represents a linear or branched C₁-C₈ alkyl radical,
   (iii) a stage which consists in mixing the anhydrous dispersion obtained in stage (i) and the anhydrous composition prepared in stage (ii), so as to obtain particles, said region (a) of which is covered at the surface with at least one layer of oxide of formula R¹ᵣ(R²X)ₓAᵥO_{3-w}, with r, w and x varying from 0 to 2, v varying from 1 to 2 and A, R¹ and R² having the same definitions as those indicated above, and said region (b) of which is not covered at the surface with said layer of oxide.

The process thus makes it possible to obtain particles locally covered with a layer of oxide, preferably a layer of metal oxide.

Stages (i) and (ii) of the process in accordance with the invention advantageously employ anhydrous compositions. This is because the presence of water during a conventional process targeted at producing a coating on the surface of the particles does not promote the formation of a coating but instead the formation of a deposit of adsorbed particles at the surface of said particles. The process according to the present invention is thus an anhydrous process, in which no addition of water is carried out in any of stages (i) to (iii). The anhydrous nature of the process according to the invention makes it possible to maintain the precursors during the covering of the particle and, in fine, makes possible localized covering on the regions of high reactivity.

Thus, the region or regions (a) of the particles obtained according to the process of the invention is or are covered with a uniform and dense layer of oxide of formula R¹ᵣ(R²X)ₓAᵥO_{3-w} and not with particles of oxide of formula R¹ᵣ(R²X)ₓAᵥO_{3-w}.

The term “anhydrous composition” is understood to mean, within the meaning of the present invention, a composition exhibiting a water content of less than 2% by weight, preferably of less than 1% by weight, with respect to the total weight of the composition. It should be noted that the presence of water in the anhydrous composition can originate from traces of water which are adsorbed by starting materials used in producing the anhydrous composition or else from the controlled addition of water to the composition.

In particular, the anhydrous composition comprises less than 100 ppm of water, preferably less than 30 ppm of water. More preferably, the particles to be coated are dispersed in a composition devoid of water.

Other subject matters, characteristics, aspects and advantages of the invention will become even more fully apparent on reading the description and examples which follow.

In accordance with the present invention, the process comprises a stage (i) which consists in dispersing the particles as defined above in an anhydrous composition.

In other words, stage (i) of the process in accordance with the present invention consists in preparing an anhydrous dispersion of the particles as defined above.

The dispersion prepared during stage (i) can be provided in the form of a stable suspension in an anhydrous composition of particles having a size ranging from 10 nm to 50 μm, preferably ranging from 100 to 5000 nanometers and more preferably ranging from 200 to 2000 nanometers.

According to a preferred embodiment, the dispersion prepared during stage (i) is a colloidal suspension in an anhydrous composition of particles having a size ranging from 200 nm to 5000 nanometers.

The size of an individual particle corresponds to the maximum dimension which it is possible to measure between two diametrically opposite points of an individual particle.

The size can be determined by transmission electron microscopy or from the measurement of a specific surface by the BET method or from a laser particle sizing.

The number-average size of the particles present in the anhydrous composition can vary from 10 to 50 000 nanometers, preferably from 200 to 5000 nanometers.

The dispersion is preferably prepared at ambient temperature, i.e. thus at a temperature which can vary from 20 to 25° C., under a controlled atmosphere, in particular for a time ranging from 10 minutes to 7 days.

Preferably, the particles dispersed in the anhydrous composition during stage (i) are particles of formula LiM′″₂O₄, in which M′″ is chosen from nickel, manganese and the mixtures of these. In particular, M′″ is chosen from mixtures of nickel and manganese.

Preferably, the particles dispersed in the anhydrous composition during stage (i) are particles of formula LiNi_{0.5-x}Mn_{1.5+x}O₄, in which x varies from 0 to 0.1.

Preferably, the particles dispersed in the anhydrous composition during stage (1) are of formula LiNi_{0.4}Mn_{1.6}O₄.

According to a preferred embodiment, stage (i) consists in preparing a suspension of particles of formula LiNi_{0.4}Mn_{1.6}O₄ having a size which can range from 200 to 5000 nanometers.

The particles are present in the anhydrous dispersion prepared during stage (i) in a concentration which can range from 0.05% to 10% by weight and which can preferably range from 3% to 5% by weight.

The anhydrous composition employed in stage (i) of the process according to the invention can comprise at least one organic solvent chosen from alkanes, such as cyclohexane or C₅ to C₈ alkanes, alcohols, N-methyl2-pyrrolidone, dimethylformamide, ethers, glycol, dimethyl silicone and their mixtures.

Preferably, the organic solvent is chosen from alcohols, in particular C₂-C₅ alcohols, especially ethanol, isopropanol or 1-propanol.

More particularly, the organic solvent is isopropanol.

According to one embodiment, the particles of formula LiNi_{0.4}Mn_{1.6}O₄ are dispersed in an organic solvent chosen from alcohols, in particular isopropanol.

In accordance with the present invention, the process comprises a stage (ii) which consists in preparing an anhydrous composition comprising at least one alkoxide compound of formula R¹ₜ(R²X)ᵤA(OR³)_{z-(t+u)} as defined above.

Preferably, stage (ii) of the process in accordance with the invention consists in preparing an anhydrous solution comprising at least one alkoxide compound of formula R¹ₜ(R²X)ᵤA(OR³)_{z-(t+u)} as defined above.

Thus, the alkoxide compounds can be completely dissolved in the anhydrous composition during stage (ii) in order to obtain a transparent solution.

Preferably, A is chosen from titanium, iron, aluminum, zinc, indium, copper, silicon, tin, yttrium, boron, chromium, manganese, vanadium, zirconium and their mixtures.

More preferably, A is chosen from the transition metals, in particular zirconium, the elements of Group IIIA, in particular aluminum, and the elements of Group IVA, in particular silicon.

According to a preferred embodiment, A is chosen from zirconium, aluminum and silicon, in particular zirconium.

Preferably, in the formula R¹ₜ(R²X)ᵤA(OR³)_{z-(t+u)}, t is equal to 0, u is equal to 0 and z is equal to 4.

Preferably, z−(t+u) is nonzero.

Preferably, R³ represents a C₂-C₄, preferably C₂-C₃ and more particularly C₃ hydrocarbon radical.

According to a preferred embodiment, the alkoxide compounds are chosen from the compounds Si(OC₂H₅)₄, Zr (OC₃H₇)₄ and Al (OC₃H₇)₃, in particular Zr(OC₃H₇)₄.

The alkoxide compounds can be present in the anhydrous composition prepared in stage (ii) in a concentration which can range from 1 to 10⁻⁵ mol·l⁻¹ and preferably in a concentration which can range from 10⁻⁴ to 10⁻² mol·l⁻¹.

The anhydrous composition prepared in stage (ii) can comprise at least one organic solvent chosen from alcohols, N-methyl-2-pyrrolidone, dimethylformamide, ethers, glycol, dimethyl silicone and their mixtures.

Preferably, the organic solvent is chosen from alcohols, in particular isopropanol.

The anhydrous composition prepared in stage (ii) can also comprise at least one collating agent.

The collating agent makes it possible to control the rate of hydrolysis and of condensation of the alkoxide precursor so as to prevent the formation of particles of oxides.

Preferably, the collating agent is chosen from β-diketones, which are saturated and unsaturated (in particular acetylacetone or 3-allylpentane-2,4-dione), and β-ketoesters (such as methacryloyloxyethyl acetoacetate, allyl acetoacetate or ethyl acetoacetate).

Preferably, the anhydrous composition comprises at least one collating agent, such as acetylacetate.

The molar ratio of the collating agent to the alkoxide compound can vary from 0.01 to 6, preferably varies from 0.1 to 4 and more preferably from 0.5 to 2.

According to a preferred embodiment, the anhydrous composition prepared during stage (ii) can comprise isopropanol and acetylacetate.

The molar ratio of alkoxide compound to specific surface of the particles to be coated (determined by the measurement of the BET specific surface) can vary from 1 to 500 μmol·cm⁻² and preferably from 5 to 250 μmol·cm⁻².

The composition prepared in stage (ii) can additionally comprise at least one catalyst.

Preferably, the catalyst can be chosen from organic acids, dibutyltin dilaurate (DBTL) and ammonia.

In particular, the catalyst is chosen from organic acids, in particular formic acid, acetic acid, citric acid, acrylic acid, methacrylic acid, methacrylamidosalicylic acid, cinnamic acid, sorbic acid, 2-acrylamido-2-methylpropanesulfonic acid, itaconic anhydride and their mixtures.

According to a preferred embodiment, stage (i) consists in preparing a colloidal suspension of particles of formula LiNi_{0.4}Mn_{1.6}O₄ in an anhydrous composition and stage (ii) consists in preparing an anhydrous composition comprising at least one alkoxide compound of formula R¹ₜ(R²X)ᵤA(OR³)_{z-(t+u)}, in which t is equal to 0, u is equal to 0, z is equal to 4, A is chosen from zirconium, silicon and aluminum and R³ represents a C₂-C₄ alkyl radical.

In accordance with the present invention, the process comprises a stage which consists in mixing the dispersion obtained in stage (i) and the anhydrous composition prepared in stage (ii) so as to obtain particles, said region (a) of which is covered at the surface with at least one layer of oxide of formula R¹ᵣ(R²X)ₓAᵥO_{3-w}, in which r, w and x vary from 0 to 2, v varies from 1 to 2 and R¹ and R² exhibit the meanings indicated above, and said region (b) of which is not covered at the surface with a layer of oxide of formula R¹ᵣ (R²X)ₓAᵥO_{3-w}.

The reaction takes place in particular at the surface of the particles between the precursor and the surface to be protected in order to result in the formation of a covalent bond between the surface of the particle and the oxide. Thus, the presence of the hydroxyl groups which are found at the surface of the particles will direct the surface reaction between the precursor and the regions of the particles to be protected so as to form a layer of oxide.

In particular, the anhydrous composition prepared during stage (ii) is added to the dispersion of particles prepared during stage (i); more particularly, the anhydrous composition prepared during stage (ii) is added dropwise to the dispersion prepared during stage (i) over a reaction time which can range from 30 minutes to 10 hours, preferably approximately 2 hours, and preferably at ambient temperature (typically between 22° C. and −5° C.).

The compounds of formula R¹ₜ(R²X)ᵤA(OR³)_{z-(t+u)} precipitate at the surface of the particles used during stage (i), in particular of the particles of formula LiM′″₂O₄, preferably of formula LiNi_{0.5-x}Mn_{1.5+x}O₄.

The supernatant is removed and the particles obtained are rinsed with an organic solvent.

The particles obtained during stage (iii) are subsequently recovered and dried at a temperature which can range from 40 to 130° C. for a time which can vary from 1 to 48 hours. The particles are annealed at a temperature which can range from 250 to 800° C. for a time which can range from 1 to 48 hours.

The particles obtained following the process in accordance with the present invention thus exhibit a layer of oxide of formula R¹ᵣ(R²X)ₓAᵥO_{3-w} at one or more regions (a) and are devoid of said layer at one or more regions (b), the region or regions (a) being more liable to react with the electrolyte based on lithium hexafluorophosphate LiPF₆ than said region or regions (b).

Preferably, A is chosen from titanium, zirconium, iron, aluminum, zinc, indium, copper, silicon and tin.

More preferably, A is chosen from the transition metals, in particular zirconium, the elements of Group IIIA, in particular aluminum, and the elements of Group IVA, in particular silicon.

According to a preferred embodiment, A is chosen from zirconium, aluminum and silicon, in particular zirconium.

Preferably, the layer of oxide is a layer of formula SiO₂, ZrO₂, SnO₂, Al₂O₃, TiO₂ or CeO₂.

The degree of coverage of the particles can vary from 5% to 95%, preferably varies from 30% to 90% and more preferably still varies from 50% to 80%.

The region or regions (a) of the particles is or are covered with a layer of formula R¹ᵣ(R²X)ₓAᵥO_{3-w} having a thickness preferably ranging from 0.25 to 10 nanometers and more preferably ranging from 0.5 to 4 nanometers.

Other characteristics and advantages of the invention will become apparent in the detailed examination of embodiments taken as nonlimiting examples of a process for the preparation of partially covered particles, which are intended to be used as active materials in a composite electrode of a lithium battery, according to the present invention and illustrated by the appended drawings, in which:

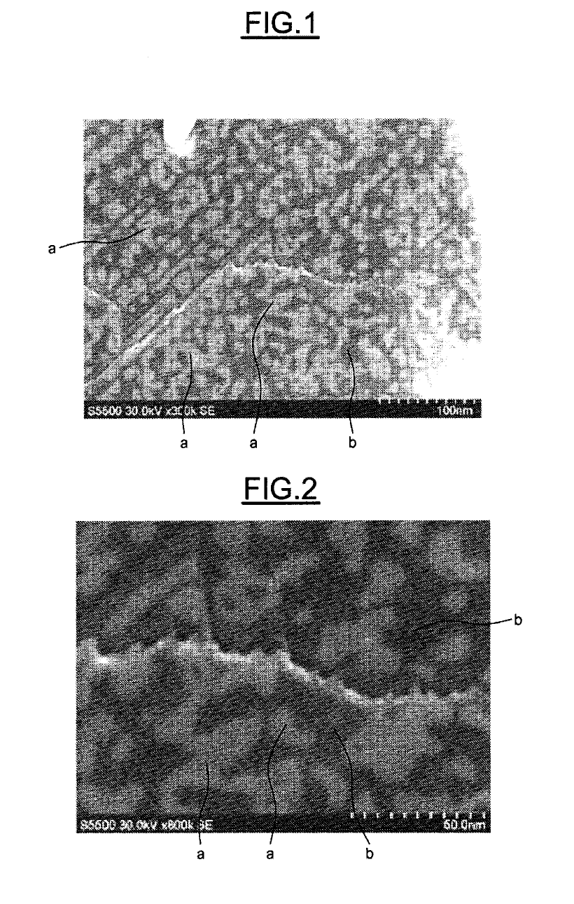

FIG. 1 represents an image obtained by scanning microscopy with a lateral resolution of 100 nanometers on the most reactive regions of the LiNi_{0.4}Mn_{1.6}O₄ particles which are covered with a layer of zirconium dioxide,

FIG. 2 represents an image obtained by scanning microscopy with a lateral resolution of 50 nanometers on the most reactive regions of the LiNi_{0.4}Mn_{1.6}O₄ particles which are covered with a layer of zirconium dioxide,

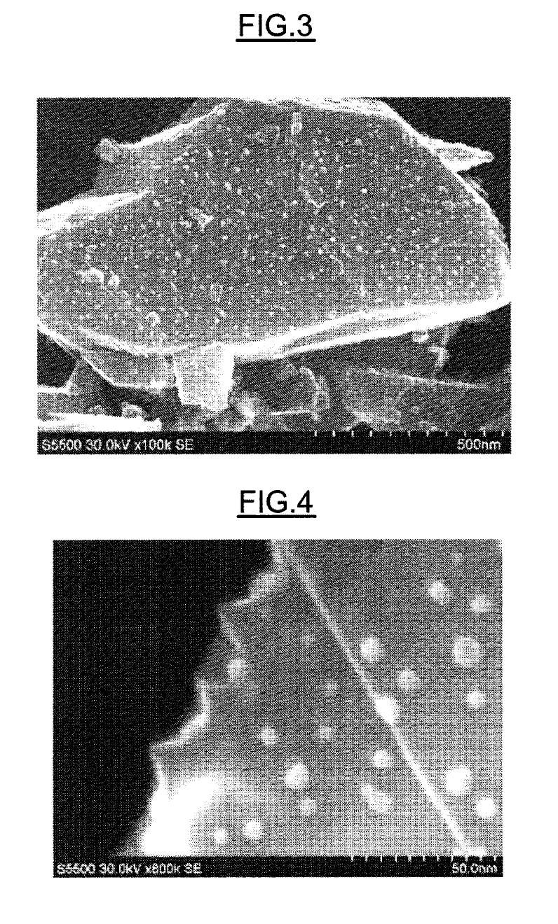

FIG. 3 represents an image obtained by scanning microscopy with a lateral resolution of 500 nanometers on the most reactive regions of the LiNi_{0.4}Mn_{1.6}O₄ particles which are covered with a deposit of particles of zirconium dioxide,

FIG. 4 represents an image obtained by scanning microscopy with a lateral resolution of 50 nanometers on the most reactive regions of the LiNi_{0.4}Mn_{1.6}O₄ particles which are covered with a deposit of particles of zirconium dioxide,

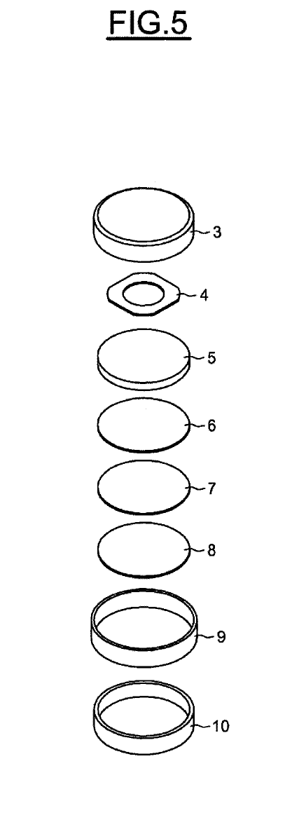

FIG. 5 represents an electrochemical cell of “button cell” type assembled in a glove box,

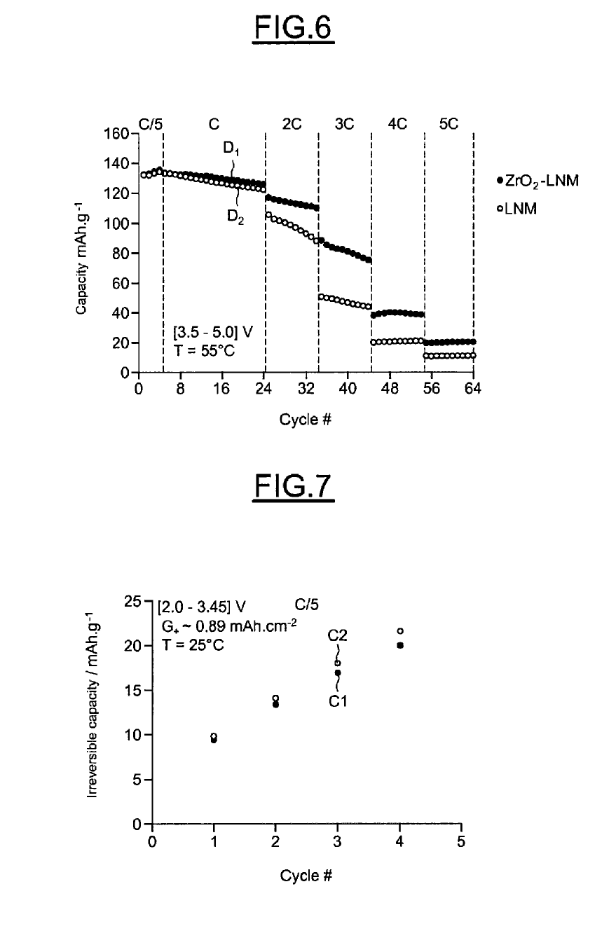

FIG. 6 represents a graph illustrating the discharge capacity of an electrochemical cell as a function of the number of cycles for a spinel active material for which the reactive regions are covered with a layer of oxide and for an uncoated active material,

FIG. 7 represents a graph illustrating the change in the irreversible capacity as a function of the number of cycles for a spinel active material for which the reactive regions are covered with a layer of oxide and for an uncoated active material.

### I. EXAMPLES OF THE PREPARATION OF ALKOXIDE-BASED SOLUTIONS

In the examples which follow, the preparation is carried out of different solutions of zirconium propoxide Zr(OPr)₄ in accordance with stage (ii) of the process according to the invention.

### Example 1

### Preparation of a Zirconium Propoxide Solution

A 10⁻¹ mol/l zirconium propoxide (Zr(OPr)₄) solution is prepared in a glove box from a commercial 70% by weight zirconium propoxide solution. To do this, 2.34 grams of the commercial solution are withdrawn and added to a 50 ml volumetric flask. The flask is made up to the filling mark with anhydrous isopropanol and the solution is stirred for 48 hours in order to obtain a transparent solution.

### Example 2

### Preparation of a Zirconium Propoxide Solution with Acetylacetone (Zr(OPr)₄/AcAc=0.25)

A 10⁻¹ mol/l zirconium propoxide (Zr(OPr)₄) solution comprising acetylacetone (AcAc) in an acetylacetone/zirconium propoxide molar ratio=0.25 is prepared from a 70% by weight commercial zirconium propoxide solution.

To do this, 2.34 grams of the commercial zirconium propoxide solution are withdrawn and added to a 50 ml volumetric flask. 0.125 gram of acetylacetone is subsequently added using a syringe.

The appearance of crystals at the bottom of the beaker is observed. These crystals correspond to the formation of a complex with acetylacetone of Zr(OPr)₄₋ₐ(AcAc)ₐ type, with 0<a≦4. The flask is made up to the filling mark with anhydrous isopropanol and the solution is stirred for 48 hours in order to obtain a transparent solution after complete dissolution of the Zr(OPr)₄₋ₐ(AcAc)ₐ complex.

### Example 3

### Preparation of a Zirconium Propoxide Solution with Acetylacetone (Zr(OPr)₄/AcAc=0.5)

A 10⁻¹ mol/l zirconium propoxide (Zr(OPr)₄) solution comprising acetylacetone (AcAc) in an acetylacetone/zirconium propoxide molar ratio=0.5 is prepared from a 70% by weight commercial zirconium propoxide solution.

To do this, 2.34 grams of the commercial zirconium propoxide solution are withdrawn and added to a 50 ml volumetric flask. 0.25 gram of acetylacetone is subsequently added using a syringe.

The appearance of crystals at the bottom of the beaker is observed. These crystals correspond to the formation of a complex with acetylacetone of Zr(OPr)₄₋ₐ(AcAc)ₐ type, with 0<a≦4. The flask is made up to the filling mark with anhydrous isopropanol and the solution is stirred for 48 hours in order to obtain a transparent solution after complete dissolution of the Zr(OPr)₄₋ₐ(AcAc)ₐ complex.

### Example 4

### Preparation of a Zirconium Propoxide Solution with Acetylacetone (Zr(OPr)₄/AcAc=0.75)

A 10⁻¹ mol/l zirconium propoxide (Zr(OPr)₄) solution comprising acetylacetone (AcAc) in an acetylacetone/zirconium propoxide molar ratio=0.75 is prepared from a 70% by weight commercial zirconium propoxide solution.

To do this, 2.34 grams of the commercial zirconium propoxide solution are withdrawn and added to a 50 ml volumetric flask. 0.375 gram of acetylacetone is subsequently added using a syringe.

The appearance of crystals at the bottom of the beaker is observed. These crystals correspond to the formation of a complex with acetylacetone of Zr(OPr)₄₋ₐ(AcAc)ₐ type, with 0<a≦4. The flask is made up to the filling mark with anhydrous isopropanol and the solution is stirred for 48 hours in order to obtain a transparent solution after complete dissolution of the Zr(OPr)₄₋ₐ(AcAc)ₐ complex.

### Example 5

### Preparation of a Zirconium Propoxide Solution with Acetylacetone (Zr(OPr)₄/AcAc=1)

A 10⁻¹ mol/l zirconium propoxide (Zr(OPr)₄) solution comprising acetylacetone (AcAc) in an acetylacetone/zirconium propoxide molar ratio=1 is prepared from a 70% by weight commercial zirconium propoxide solution.

To do this, 2.34 grams of the commercial zirconium propoxide solution are withdrawn and added to a 50 ml volumetric flask. 0.5 gram of acetylacetone is subsequently added using a syringe.

The appearance of crystals at the bottom of the beaker is observed. These crystals correspond to the formation of a complex with acetylacetone of Zr(OPr)₄₋ₐ(AcAc)ₐ type, with 0<a≦4. The flask is made up to the filling mark with anhydrous isopropanol and the solution is stirred for 48 hours in order to obtain a transparent solution after complete dissolution of the Zr (OPr)₄₋ₐ (AcAc)ₐ complex.

### Example 6

### Preparation of a Zirconium Propoxide Solution with Acetylacetone (Zr(OPr)₄/AcAc=1.5)

A 10⁻¹ mol/l zirconium propoxide (Zr(OPr)₄) solution comprising acetylacetone (AcAc) in an acetylacetone/zirconium propoxide molar ratio=1.5 is prepared from a 70% by weight commercial zirconium propoxide solution.

To do this, 2.34 grams of the commercial zirconium propoxide solution are withdrawn and added to a 50 ml volumetric flask. 0.75 gram of acetylacetone is subsequently added using a syringe.

The appearance of crystals at the bottom of the beaker is observed. These crystals correspond to the formation of a complex with acetylacetone of Zr(OPr)₄₋ₐ(AcAc)ₐ type, with 0<a≦4. The flask is made up to the filling mark with anhydrous isopropanol and the solution is stirred for 48 hours in order to obtain a transparent solution after complete dissolution of the Zr(OPr)₄₋ₐ(AcAc)ₐ complex.

### II. EXAMPLES OF THE PREPARATION OF PARTICLES OF A PARTIALLY COATED ACTIVE MATERIAL

### Example 1

### Preparation of Partially Coated LiNi_{0.4}Mn_{1.6}O₄ Particles

The LiNi_{0.4}Mn_{1.6}O₄ material is prepared in accordance with the process described in the patent application WO 2007/023235.

1 gram of LiNi_{0.4}Mn_{1.6}O₄ material is dispersed in 32 ml of anhydrous isopropanol under a controlled atmosphere (Ar). The dispersing of the material is carried out by magnetic stirring for two hours and then using a vacuum disperser, sold under the Dispermat® name, at 800 revolutions per minute for 10 minutes. Stirring with the magnetic bar is subsequently maintained in order to retain a good dispersion throughout the experiment.

A solution is prepared from the solution described in example 3. To do this, 1 ml of the mother solution illustrated in example 3 (part I) is withdrawn and added to a 100 ml volumetric flask, and the flask is made up to the filling mark with anhydrous isopropanol in the glove box.

This solution is added dropwise to the dispersion of LiNi_{0.4}Mn_{1.6}O₄ particles prepared above.

The addition of the 100 ml is carried out in 30 minutes with vigorous stirring with the magnetic bar. After the dispersion and the solution have reacted for 2 hours, the mixture is centrifuged at a speed of 4000 revolutions per minute for 3 minutes. The supernatant is removed and the powder is rinsed with a large excess of isopropanol. The powder is subsequently recovered and dried in an oven at 100° C. under air for 3 hours.

Finally, the powder is annealed at 500° C. under air for 5 hours.

Particles, known as ZrO₂—LiNi_{0.4}Mn_{1.6}O₄, are obtained which have a layer of zirconium dioxide ZrO₂ localized on the most reactive regions of the particles in accordance with FIGS. 1 and 2.

### Images Obtained by Scanning Electron Microscopy

FIG. 1 represents an image obtained by scanning electron microscopy with a lateral resolution of 100 nanometers of the LiNi_{0.4}Mn_{1.6}O₄ particles obtained in accordance with the preparation process of example 1 of part II.

FIG. 1 represents a localized region (a) of the LiNi_{0.4}Mn_{1.6}O₄ particles which is covered with the layer of zirconium dioxide ZrO₂ and also a region (b) not covered with the layer of zirconium dioxide.

Consequently, FIG. 1 shows that the process results in a localized coating on the most reactive regions of the particles.

In the same way, FIG. 2 represents an image obtained by scanning electron microscopy with a lateral resolution of 50 nanometers of the LiNi_{0.4}Mn_{1.6}O₄ particles obtained in accordance with the preparation process of example 1 of part II.

### Example 2

### Preparation of the LiNi_{0.4}Mn_{1.6}O₄ Particles Covered with a Deposit of ZrO₂ Particles

The LiNi_{0.4}Mn_{1.6}O₄ material is prepared in accordance with the process described in the patent application WO 2007/023235.

1 gram of LiNi_{0.4}Mn_{1.6}O₄ material is dispersed in 32 ml of anhydrous isopropanol under a controlled atmosphere (Ar). The dispersing of the material is carried out by magnetic stirring for two hours and then using a vacuum disperser, sold under the Dispermat® name, at 800 revolutions per minute for 10 minutes. Stirring with the magnetic bar is subsequently maintained in order to retain a good dispersion throughout the experiment. 1 ml of water is added to the dispersion obtained, which is subsequently stirred for two hours.

A solution is prepared from the solution described in example 3. To do this, 1 ml of the mother solution illustrated in example 3 is withdrawn and added to a 100 ml volumetric flask, and the flask is made up to the filling mark with anhydrous isopropanol in the glove box.

This solution is added dropwise to the dispersion of LiNi_{0.4}Mn_{1.6}O₄ particles prepared above.

The addition of the 100 ml is carried out in 30 minutes with vigorous stirring with the magnetic bar. After the dispersion and the solution have reacted for 2 hours, the mixture is centrifuged at a speed of 4000 revolutions per minute for 3 minutes. The supernatant is removed and the powder is rinsed with a large excess of isopropanol. The powder is subsequently recovered and dried in an oven at 100° C. under air for 3 hours.

Finally, the powder is annealed at 500° C. under air for 5 hours.

LiNi_{0.4}Mn_{1.6}O₄ particles are obtained, the surface of which is covered with a deposit of particles of zirconium dioxide ZrO₂ and not a layer of zirconium dioxide ZrO₂ localized on the most reactive regions of the particles, as could be observed in example 1 of part II not involving the addition of water during the process.

### Images Obtained by Scanning Electron Microscopy

FIG. 3 represents an image obtained by scanning electron microscopy with a lateral resolution of 500 nanometers of the LiNi_{0.4}Mn_{1.6}O₄ particles obtained in accordance with the preparation process of example 2 of part II.

FIG. 3 represents the surface of an LiNi_{0.4}Mn_{1.6}O₄ particle which is covered with a deposit of particles of zirconium dioxide ZrO₂.

Consequently, FIG. 3 shows that a process identical to that of the invention employing a composition comprising water results in LiNi_{0.4}Mn_{1.6}O₄ particles, the surface of which is covered with a deposit of ZrO₂ particles and not a layer of ZrO₂.

In the same way, FIG. 4 represents an image obtained by scanning electron microscopy with a lateral resolution of 50 nanometers of the LiNi_{0.4}Mn_{1.6}O₄ particles obtained in accordance with the preparation process of example 2 of part II.

FIG. 4 represents the surface of an LiNi_{0.4}Mn_{1.6}O₄ particle which is covered with a deposit of particles of zirconium dioxide ZrO₂.

### Example 3

### Preparation of Partially Coated LiNi_{0.4}Mn_{1.6}O₄ Particles

The LiNi_{0.4}Mn_{1.6}O₄ material is prepared in accordance with the process described in the patent application WO 2007/023235.

1 gram of LiNi_{0.4}Mn_{1.6}O₄ material is dispersed in 32 ml of anhydrous isopropanol under a controlled atmosphere (Ar). The dispersing of the material is carried out by magnetic stirring for two hours and then using a vacuum disperser, sold under the Dispermat® name, at 800 revolutions per minute for 10 minutes. Stirring with the magnetic bar is subsequently maintained in order to retain a good dispersion throughout the experiment.

A solution is prepared from the solution described in example 3. To do this, 1 ml of the mother solution illustrated in example 3 (part I) is withdrawn and added to a 100 ml volumetric flask, and the flask is made up to the filling mark with anhydrous isopropanol in the glove box.

This solution is added dropwise to the dispersion of LiNi_{0.4}Mn_{1.6}O₄ particles prepared above.

The addition of the 100 ml is carried out in 30 minutes with vigorous stirring with the magnetic bar. After the dispersion and the solution have reacted for 5 hours, the mixture is centrifuged at a speed of 4000 revolutions per minute for 3 minutes. The supernatant is removed and the powder is rinsed with a large excess of isopropanol. The powder is subsequently recovered and dried in an oven at 100° C. under air for 3 hours.

Finally, the powder is annealed at 500° C. under air for 5 hours.

Particles, known as ZrO₂—LiNi_{0.4}Mn_{1.6}O₄, are obtained which have a layer of zirconium dioxide ZrO₂ localized on the most reactive regions of the particles.

### III. EXAMPLE OF THE PREPARATION OF A COMPOSITE ELECTRODE BASED on ZrO₂— LiNi_{0.4}Mn_{1.6}O₄ PARTICLES

The material obtained in example 1 of part II, that is to say the particles referred to as ZrO₂—LiNi_{0.4}Mn_{1.6}O₄, is used for the preparation of a composite electrode (cathode) for lithium-ion batteries.

1 gram of the ZrO₂—LiNi_{0.4}Mn_{1.6}O₄ material is mixed with 33.7 mg of carbon black, sold under the name Carbon Super P®, and carbon fibers having a high tenacity, sold under the Tenax® name.

The dry powders are first homogenized for 5 minutes using a spatula. The powders are subsequently mixed in an agate mortar while adding 3 ml of cyclohexane, until the cyclohexane has completely evaporated. The homogenized mixture of powders is recovered in a beaker.

Subsequently, 468 mg of a solution of thermoplastic polyvinylidene fluoride dissolved at 12% by weight in N-methyl-2-pyrrolidone are added, followed by the addition of 780 mg of N-methyl-2-pyrrolidone. The combined material is mixed for 15 minutes using a spatula in order to obtain a completely uniform ink.

The ink is subsequently deposited, using a scraper, on a substrate made of aluminum. The thickness of ink deposited is 100 μm before drying. The ink thus deposited is subsequently dried in an oven at 55° C. under air for 12 hours. Circular pellets, with a diameter of 14 mm, are subsequently cut out and are compressed at 6.5 tonnes per cm² in order to provide the composite electrode with good cohesion.

### IV. ELECTROCHEMICAL PERFORMANCE OF THE COATED MATERIAL

### 4.1. Preparation of Electrodes

A positive electrode (cathode) is prepared in accordance with example III.

At the same time, pellets of Li₄Ti₅O₁₂ type are used to form the negative electrode (anode). These electrodes are prepared in a similar manner to the positive electrode and comprise 82% by weight of Li₄Ti₅O₁₂, 6% of carbon fibers sold under the name Carbon Super P®, 6% by weight of carbon fibers sold under the name Tenax® and 6% by weight of polyvinylidene fluoride.

### 4.2. Preparation of the Electrochemical Cell

The performance of the coated materials will be evaluated via cells of “button cell” type, such as the batteries sold under the CR2032 name.

The electrochemical cell, assembled in “button cell” manner under an Ar atmosphere in a glove box, is represented in FIG. 5.

FIG. 5 represents the electrochemical cell assembled in the glove box which comprises a cap (3) and a bottom (10).

The electrochemical cell comprises the negative electrode (6), i.e. the anode prepared in accordance with example 4.1, and the positive electrode (8), i.e. the cathode prepared in accordance with example III. The two electrodes (6) and (8) are separated by a separator (7) made of polyethylene of Celgard 2600 type, impregnated with 150 μl of an electrolyte composed of a mixture of carbonates (ethylene carbonate (EC)/propylene carbonate (PC)/dimethyl carbonate (DMC) 1/1/3 by volume) and of a lithium salt (LiPF₆) at a concentration of 1 mol·l⁻¹.

The electrochemical cell is crimped after having added a shim made of stainless steel (5) and a spring (4) in order to maintain a constant pressure on the electrodes during the charging-discharging cycles of the battery. A leaktight seal (9) is positioned between the positive electrode (8) and the bottom of the glove box (10).

### 4.3. Measurement of the Electrochemical Performance

The tests on charging and discharging are carried out at different rates between C/5 and 5C.

A rate C/n corresponds to complete discharge of the battery in n hours. For example, a rate of 2C, thus C/0.5, corresponds to complete discharging (respectively charging) of the battery in 0.5 hours.

FIG. 6 represents the discharge measurements at different rates and at moderate temperature (55° C.) as a function of the number of cycles for a coated material prepared in accordance with example 3 (curve D₁ [ZrO₂-LNM]) and an uncoated material (curve D₂ [LNM]) at an operating potential of between 3 and 5 volts. These measurements show that the active material which is not coated with a layer of zirconium dioxide has an initial discharge capacity similar to that of the coated material.

However, a fall in capacity from the 5th cycle at a rate C is also observed which is greater for the active material devoid of coating than the material prepared in accordance with the process of the invention. This confirms the good stability of the material, the reactive regions of which have been protected by a layer of zirconium dioxide according to the process in accordance with the invention.

The following discharges, carried out at 2C, 3C, 4C and 5C, show that the power performance of the material coated with ZrO₂ is better than that of the material devoid of coating. This originates from the fact that the insertion of lithium ions is not limited by this coating, the coverage of which is not total. The circulation of the Li⁺ ions is thus not hindered as the ions are not confronted in passing by a physical barrier, that is to say relating to the presence of the oxide layer, to be crossed. With the active material not comprising the coating, the reactivity of said material is so high that the surface of the particles is modified because of the reactivity of the electrode/electrolyte interface, which gradually prevents the Li⁺ ions from passing.

When the coating covers the most reactive regions of the particles, the reactivity with the electrolyte is limited and thus the electrode/electrolyte interface is less disturbed, which improves the stability of the system over time.

### 4.4. Measurements of Self Discharges

The coated active material exhibits better resistance than the uncoated material, thus clearly showing the protective properties of the coating at the most reactive regions of the spinel particles.

Specifically, the self-discharge of the battery maintained in the charged position (charge state=100%) for 15 days is 21% for the uncoated spinel material, whereas it is no more than 18% for the ZrO₂—LiNi_{0.4}Mn_{1.6}O₄ material, the most reactive regions of which are protected by ZrO₂. Furthermore, while the discharge capacity of the battery observed for the first four cycles is fairly similar, whether or not the material is coated, an irreversible discharge share is observed with regard to the capacity which is greater for the uncoated material (3%) than for the coated material (2%). This, combined with the fact that the loss in capacity observed as a function of the number of cycles is greater for the uncoated material than for the coated material, shows that the coated material has a better stability than the bare material.

Likewise, FIG. 7 represents the change in the irreversible capacity of the ZrO₂—LiNi_{0.4}Mn_{1.6}O₄ and uncoated LiNi_{0.4}Mn_{1.6}O₄ materials as a function of the number of cycles at a temperature of 25° C. and an operating potential located between 2 and 3.45 volts. The curve C₁ represents the change in the irreversible capacity of the ZrO₂—LiNi_{0.4}Mn_{1.6}O₄ materials as a function of the number of cycles and the curve C₂ represents the change in the irreversible capacity of the LiNi_{0.4}Mn_{1.6}O₄ materials as a function of the number of cycles.

FIG. 7 shows that the ZrO₂—LiNi_{0.4}Mn_{1.6}O₄ material, for which the reactive regions are coated with the layer of ZrO₂, exhibits a lower irreversible capacity than that of the uncoated material, in particular after 4 cycles, at a rate of C/5. This shows that the coulombic efficiency is improved.

1. A process for producing particles, the process comprising:
(i) dispersing, in a first anhydrous composition, comprising at least one compound selected from the group consisting particles of lithium oxide of formulae:
LiM′PO₄, where M′ is at least one element selected from the group consisting of iron, cobalt and manganese,
LiM″O₂, where M″ is at least one element selected from the group consisting of nickel, cobalt, manganese and aluminum,
LiM′″₂O₄, where M″ is at least one element selected from the group consisting of nickel and manganese, and
Li₄Ti₅O₁₂;
(ii) preparing a second anhydrous composition comprising an alkoxide compound of formula R¹ₜ(R²X)ᵤA(OR³)_{z-(t+u)},
where:
t varies from 0 to 2,
u varies from 0 to 2,
the sum t+u varies from 0 to 2,
z varies from 2 to 4,
X corresponds to a halogen atom,
A is selected from the group consisting of a transition metal and an element of Groups IIIA and IVA of the Periodic Table of the Elements,
R¹ represents a linear or branched C₁-C₈ alkyl radical,
R² represents a single bond or a linear or branched C₁-C₈ alkyl radical,
R³ represents a linear or branched C₁-C₈ alkyl radical; and
(iii) mixing the first anhydrous dispersion obtained in (i) and the second anhydrous composition prepared in (ii), so as to obtain particles,
wherein the particles are suitable for active materials in a composite electrode of a lithium battery;
the particles comprise a region (a) and a region (b), the region (a) being more liable to react with an electrolyte based on lithium hexafluorophosphate LiPF₆ than the region (b);
a surface of the region (a) is covered with at least one layer of oxide of formula R¹ᵣ(R²X)ₓAᵥO_{3-w}, with r, w and x varying from 0 to 2, v varying from 1 to 2; and
a surface of the region (b) is not covered with the layer of oxide.

2. The process as claimed in claim 1,
wherein the dispersing (i) comprises preparing a colloidal suspension of particles having a size ranging from 200 nm to 5000 nm in the first anhydrous composition.

3. The process as claimed in claim 1,
wherein the particles dispersed in the first anhydrous composition are particles of formula LiM′″₂O₄.

4. The process as claimed in claim 1,
wherein the particles correspond to the formula LiNi_{0.5-x}Mn_{1.5+x}O₄,
where x varies from 0 to 0.1.

5. The process as claimed in claim 1,
wherein the first anhydrous composition comprises an organic solvent.

6. The process as claimed in claim 5,
wherein the organic solvent is at least one compound selected from the group consisting of an alcohol, N-methyl-2-pyrrolidone, dimethylformamide, an ether, glycol, and dimethyl silicone.

7. The process as claimed in claim 1,
where A is at least one element selected from the group consisting of titanium, iron, aluminum, zinc, indium, copper, silicon, tin, yttrium, boron, chromium, manganese, vanadium and zirconium.

8. The process as claimed in claim 1,
wherein the alkoxide compound is selected from the group consisting of Si(OC₂H₅)₄, Zr(OC₃H₇)₄ and Al(OC₃H₇)₃.

9. The process as claimed in claim 1,
wherein the second anhydrous composition further comprises a collating agent.

10. The process as claimed in claim 9,
wherein the collating agent is a saturated or unsaturated β-diketone or a β-ketoester.

11. The process as claimed in claim 9,
wherein a molar ratio of the collating agent to the alkoxide compound is from 0.01 to 6.

12. The process as claimed in claim 1,
wherein a molar ratio of the alkoxide compound to specific surface of the particles to be coated is from 1 to 500 μmol·cm⁻².

13. The process as claimed in claim 1,
wherein the at least one layer of oxide is selected from the group consisting of SiO₂, ZrO₂, SnO₂, Al₂O₃, TiO₂ and CeO₂.

14. The process as claimed in claim 1,
wherein the dispersing (i) comprises preparing a colloidal suspension of particles of formula LiNi_{0.4}Mn_{1.6}O₄ in the first anhydrous composition and
the preparing (ii) comprises preparing the second anhydrous composition comprising an alkoxide compound of formula:
R¹ₜ(R²X)ᵤA(OR³)_{z-(t+u)},
wherein
t is equal to 0,
u is equal to 0,
z is equal to 4 and
A is selected from the group consisting of zirconium, silicon and aluminum.

15. The process as claimed in claim 1,
wherein a degree of coverage of the particles is from 5% to 95%.

16. The process as claimed in claim 8,
wherein the alkoxide compound is Zr(OC₃H₇)₄.

17. The process as claimed in claim 10,
wherein the β-diketone is acetylacetone or 3-allylpentane-2,4-dione.

18. The process as claimed in claim 10,
wherein the β-ketoester is methacryloyloxyethyl acetoacetate, allyl acetoacetate or ethyl acetoacetate.
